(19) United States
(12) Patent Application Publication
(10) Pub. No.: US 2005/0096954 A1
(43) Pub. Date: May 5, 2005

(54) Method and apparatus for the discovery of trade secrets, including the collection, compilation, correlation, integration, categorization and reporting of data about trade secrets

(76) Inventors: R. Mark Halligan, Naperville, IL (US); Richard F. Weyand, Naperville, IL (US)

Correspondence Address: WELSH & KATZ, LTD, 120 S RIVERSIDE PLAZA, 22ND FLOOR, CHICAGO, IL, 60606, US

(21) Appl. No.: 10/701,889

(22) Filed: Nov. 5, 2003

(51) Int. Cl. G06F 17/60

(52) U.S. Cl. 705/7

(57) ABSTRACT

A method and apparatus are provided for discovering trade secrets of an organization. The method includes the steps of collecting trade secret information from a plurality of persons of the organization, analyzing the trade secret information using mathematical and logical formulae to identify a plurality of trade secrets of the organization, and generating a report regarding the identified trade secrets of the organization.

### FIELD OF THE INVENTION

The subject patent is in the area of accounting methods, specifically, accounting for trade secret intellectual property assets. It is intended to be used primarily for the discovery of trade secrets, including the collection, compilation, correlation, integration, categorization and reporting of data about trade secrets, ensuring that potential trade secret intellectual property is identified and documented so that it can be subsequently valued, protected, and defended in litigation.

### BACKGROUND OF THE INVENTION

This invention relates generally to the field of accounting methods and more particularly to methods and apparatus for the discovery of trade secrets, including the collection, compilation, correlation, integration, categorization and reporting of data about trade secrets. The terms “trade secret”, “trade secret information”, “trade secret asset”, and “trade secret information asset” are synonyms within the context of this invention.

Trade secret is a recognized intellectual property right under the laws of the United States and many foreign countries. The other intellectual property protection provided to ideas is patent protection. Patent protection, unlike trade secret protection, requires disclosure. In an industrial economy, patents were the favored intellectual property right. In the information economy, disclosure of the information required to obtain a patent is increasingly viewed as disadvantageous. There has therefore been growth in the use of the trade secret protection to safeguard companies' intellectual property.

Unlike patents, trademarks, or copyrights, there is no disclosure process for trade secrets. There is no equivalent to the United States Patent and Trademark Office or the United States Copyright Office for trade secrets, nor is there any equivalent to the patent examiner or trademark examiner. No equivalent to the patent certificate or trademark certificate or copyright registration is issued. The lack of such a disclosure process and its concomitant documentation requirements has had the result that the collection and documenting of trade secrets in many companies is haphazard or non-existent.

Information technology has exacerbated this failure to document, by causing the company's trade secret information to be scattered across the company, in desktop computers, file servers, backup tapes, and portable media such as floppy disks and CD-ROMs. Further, information technology has made the creation of trade secrets easier, causing a proliferation of valuable trade secret information within the company.

Increased employee mobility and the increased use of temporary employees, contract workers, and outside consultants has also exacerbated this failure to document. The employee who created, used, or stored the trade secret may no longer be with the company. His computer files relating to the trade secret may be lost or dissipated within the company. Indeed, the knowledge of the existence of the trade secret itself may have left the company.

The result is that most companies have little knowledge of what their trade secrets are, or where they are documented. This situation makes it difficult to secure trade secrets, to value trade secrets, to realize the maximum benefit from trade secrets, and to defend against the infringement or theft of trade secrets in court.

At the same time, the incidence and magnitude of trade secret thefts are increasing. Information technology, through the means of high-density portable media and high-speed communications, has made the theft of trade secrets much easier, resulting in an increased need for proper documentation in order to secure trade secrets from theft and successfully litigate for their protection. Increased employee mobility and increased use of non-employee workers also increases the likelihood of theft, further increasing the need for proper documentation in order to secure trade secrets from theft and successfully litigate for their protection.

The accounting profession has solved similar problems in documenting the existence of physical and financial assets, but these methods have defied application to trade secret information assets. The accounting method for physical and financial assets constitutes an inventory or audit. The inventory comprises the identification of the locations where assets exist, the counting of the assets, grouping of the assets into categories, and the valuation of the assets.

Similar audits of trade secret information assets have been urged by legal, security, and accounting professionals for many years. The ephemeral and dynamic nature of trade secrets makes such a process very difficult, however. Whereas all employees of a firm can readily agree on the existence, location, and value of a physical asset, such as a company truck, there is no similar consensus on what constitutes a trade secret, where it is, or what its value is.

Additionally, the physical asset of a truck must be ‘created’ through an itemized expenditure of company funds, and will continue to exist as an asset on the company's books until sold. In contrast, trade secrets are created every day by employees of the company in the normal course of their duties, without any accounting entry for a specific expenditure. In addition, trade secrets often have a short shelf life, as they can be rendered obsolete and made valueless by external events, such as the independent discovery and disclosure by a competitor.

Further, the truck exists, it occupies a physical space. It is easy to discover by looking in the company's garage or motor pool. Trade secrets occupy no physical space, and cannot be discovered by physical means.

The ephemeral and dynamic nature of trade secrets therefore makes the traditional steps of an inventory more difficult, and a trade secret audit therefore requires additional steps to be performed. This makes trade secret audits expensive. One of the inventions we claim is a system to automate the discovery steps in a trade secret audit to reduce the cost of such audits.

Additionally, the manual subjective methods of a traditional trade secret audit result in findings that may vary markedly from one team of auditors to another. One of the inventions we claim is a method for performing trade secret audits in an objective manner, with results that are predictable and reproducible.

Finally, trade secret audits are a mere “snapshot” of the current state of a company's trade secret information assets at a particular moment in time. The dynamic nature of the typical trade secret portfolio cannot be reliably captured in such a static view. One of the inventions we claim is a system to perform trade secret discovery continuously and dynamically, to turn the static view of a traditional audit into a dynamic view of the company's evolving trade secret environment on a continuous basis.

The combination of the expense of trade secret audits and the limited benefit of a static view has resulted in trade secret audits not being performed at all by virtually all companies. One of the inventions we claim provides a cost-effective method of performing dynamic trade secret discovery on a continuous basis, providing a superlative cost-benefit ratio over the existing static, manual, and labor-intensive methods.

The traditional trade secret audit begins with the identification of the people with knowledge of the company's trade secrets. This information is gathered through employee interviews conducted by the trade secret auditors. One of the inventions we claim is a system to conduct employee interviews about the identification of people with knowledge of the company's trade secrets by automated means, eliminating the expense of trade secret auditors in this process.

The traditional trade secret audit continues with the identification of the locations of trade secret information assets. This information is gathered through employee interviews conducted by the trade secret auditors. One of the inventions we claim is a system to conduct employee interviews about the locations of trade secret information assets by automated means, eliminating the expense of trade secret auditors in this process.

The traditional trade secret audit continues with the identification of the trade secret information assets themselves. This information is also gathered through employee interviews conducted by the trade secret auditors. One of the inventions we claim is a system to conduct employee interviews about the identification of the trade secret information assets themselves by automated means, eliminating the expense of trade secret auditors in this process.

The traditional trade secret audit continues with the compilation of the interview data into lists of the potential trade secrets through the correlation of references to the same trade secret from multiple interviewees and integration of data relating to the same trade secret from multiple interviewees into a single entry. This process is traditionally manually performed by trade secret auditors in a subjective manner from their interview notes. One of the inventions we claim is a system to perform compilation of the interview data into lists of the potential trade secrets through a process of correlation and integration in an objective manner by automated means, eliminating the expense of trade secret auditors in this process.

The traditional trade secret audit continues with the categorizing and grouping of the potential trade secrets into broad categories. This process is traditionally manually performed by trade secret auditors in a subjective manner from their lists of the potential trade secrets. One of the inventions we claim is a system to perform the categorizing and grouping of the potential trade secrets into broad categories in an objective manner by automated means, eliminating the expense of trade secret auditors in this process.

The traditional trade secret audit continues with the preparation of a final report, or inventory, including the categorized list of the potential trade secrets and supporting documentation. This process is traditionally manually performed by trade secret auditors in a subjective manner to summarize their activities. One of the inventions we claim is a system to prepare a final report, or inventory, including the categorized list of the potential trade secrets and supporting documentation in an objective manner by automated means, eliminating the expense of trade secret auditors in this process.

The traditional trade secret audit continues with the search through the locations where trade secrets are stored to identify documents relating to the trade secrets. This process is traditionally manually performed by trade secret auditors in a subjective manner from their interview notes of the locations of trade secrets. One of the inventions we claim is a system to generate search criteria for searching through the locations of trade secrets to identify documents relating to the trade secrets in an objective manner by automated means, eliminating the expense of trade secret auditors in this process.

The traditional trade secret audit continues with the cross-referencing of the results of the search process to associate to each trade secret the documents relating to the trade secret. This process is traditionally manually performed by trade secret auditors in a subjective manner during a search of the locations of the trade secrets. One of the inventions we claim is a system to cross-reference the results of the search process to associate to each trade secret the documents relating to the trade secret in an objective manner by automated means, eliminating the expense of trade secret auditors in this process.

The traditional trade secret audit continues with the generation of sets of criteria for filtering content of the company's internet firewall to prohibit the transmission of trade secret information through the company's email and web server systems. This process is traditionally manually performed by trade secret auditors in a subjective manner from the final report. One of the inventions we claim is a system to generate sets of criteria for filtering content of the company's internet firewall to prohibit the transmission of trade secret information through the company's email and web server systems in an objective manner by automated means, eliminating the expense of trade secret auditors in this process.

Finally, the information gathered within a traditional trade secret audit can be used to generate sets of criteria for monitoring the creation and access of information about trade secrets by an electronic document scanner operating on files read from or written to the company's email and file servers. While this process is not traditionally performed by trade secret auditors, this process would need to be manually performed in a subjective manner prior to the current invention. One of the inventions we claim is a system to generate sets of criteria for monitoring the creation and access of information about trade secrets by an electronic document scanner operating on files read from or written to the company's email and file servers in an objective manner by automated means, eliminating the expense of trade secret auditors in this process.

The resulting trade secret audit must periodically be either re-performed or updated to generate a new, current static picture of the company's trade secrets. This process is traditionally manually performed by trade secret auditors. One of the inventions we claim is a system that continuously re-performs the discovery steps of the trade secret audit, providing a dynamic trade secret audit report that is always current.

There is a need for a system to aid in the discovery of trade secrets, including the collection, compilation, correlation, integration, categorization and reporting of data about trade secrets. This need is indicated by the failure of companies to avail themselves of manual services to perform these professionally recommended tasks due to their poor cost-effectiveness. This need is increasing, due to the increasing ease of theft due to information technology and employee mobility.

Further, the cost-effective auditing of trade secrets can be expected to yield similar benefits to the company that the auditing of a company's physical and financial assets has had. Audited assets can be insured, can be used as collateral for loans, can be bought, sold, and licensed, and provide a more accurate view of the company's position to officers, directors, shareholders and regulators.

Nevertheless, there is no system in the prior art to provide the unique methods required to conduct employee interviews about the people knowledgeable of the company's trade secrets, to conduct employee interviews about the location of trade secrets, to conduct employee interviews about the identification of trade secrets, to perform compilation of the interview data into lists of the potential trade secrets through a process of correlation and integration, to perform the categorizing and grouping of the potential trade secrets into broad categories, to prepare a final report, or inventory, including the categorized list of the potential trade secrets and supporting documentation, to submit search criteria and search locations to a data mining application and to cross-reference those results to information about trade secrets, to submit search criteria to a content filtering application, to submit search criteria to an electronic document scanning application, and to perform other such documentation and analysis as performed by the current invention.

Many intellectual property law firms and information technology consultants offer manual trade secret audit services (e.g.: Welsh & Katz, Ltd.; Leonard, Street and Deinard; Rider Bennett, LLP; Lexicon Communications Corp.; Pro-Tec Data), but these firms do not offer the automated methods of collection and analysis of trade secret information assets provided by the current invention.

Automated methods for the calculation of the value of a known, existing intellectual property portfolio by comparison to representative intellectual property portfolios (cf. U.S. Pat. Nos. 5,999,907, 6,154,725 and 6,263,314 and their respective references) exist, but do not address the collection and analysis of interview data to create said known, existing intellectual property portfolio, which collection and analysis of interview data is provided by the current invention.

Similarly, automated methods for the characterization of physical documents and the sorting of said physical documents based on said characterization (cf. U.S. Pat. No. 5,953,702 and its respective references) exist, but do not address the characterization and sorting of ideas, i.e., trade secret intellectual property, which characterization and sorting of ideas is provided by the current invention.

Finally, automated methods for the documentation, analysis, auditing, accounting, protection, registration, and verification of trade secrets (cf. U.S. pat. appl. Nos. 20010044737 ('737) and 20020077941 ('941), by the current inventors) exist, but these methods do not address the collection, compilation, correlation, integration, categorization and reporting of data about trade secrets, which collection, compilation, correlation, integration, categorization and reporting of data about trade secrets is provided by the current invention.

The current invention can further be seen to be distinct from the prior art described in the '737 and '941 applications in the following way. The current invention collects potentially redundant data from multiple individuals and condenses this data into non-redundant potential trade secrets. The invention of the '737 and '941 applications accepts input of non-redundant potential trade secrets, applies legal criteria to determine if they are actual trade secrets, and then provides management and accounting tools to value the trade secrets, track employee exposure, assess threats, and other activities.

In particular, the current invention is useful if the potential trade secrets are not already known, in order to determine the potential trade secrets. The invention of the '737 and '941 applications is useful if the potential trade secrets are known, in order to assess and manage the potential trade secrets. The two inventions provide different functions and meet different needs. They may be used independently, and each provides different benefits when so used. They may also be used together, with the potential trade secret list output of the current invention provided as input to the invention of the '737 and '941 applications.

Accordingly, it is an object of this invention to provide improved methods and means of discovery of trade secrets, including the collection, compilation, correlation, integration, categorization and reporting of data about trade secrets, including the methods disclosed herein for conducting employee interviews about persons knowledgeable of the company's trade secrets, the location of trade secrets, and the identification of trade secrets, performing compilation of the interview data into lists of the potential trade secrets through a process of correlation and integration, performing the categorizing and grouping of the potential trade secrets into broad categories, preparing a final report, or inventory, including the categorized list of the potential trade secrets and supporting documentation, preparing identification signatures of the trade secrets for data mining, content filtering, and electronic document scanning, and performing other such documentation, processes, and analyses as performed by the current invention.

### SUMMARY OF THE INVENTION

These and other objectives of the system are accomplished by a method and apparatus for discovering the trade secrets of an organization. The method includes the steps of collecting trade secret information from a plurality of persons of the organization, analyzing the trade secret information using mathematical and logical formulae to identify a plurality of trade secrets of the organization, and generating a report regarding the identified trade secrets of the organization.

More specifically, a system is provided in which selected data and other information about potential trade secrets are collected and characterized and entered into a specialized database with certain unique functions. The system includes a method and apparatus for analyzing multiple redundant entries from a plurality of persons to result in a non-redundant list of potential trade secrets and generating one or more reports. The method may include the steps of correlating and integrating redundant entries to generate a compilation of non-redundant entries.

The initial data collection takes the form of scripted, automated interviews of a plurality of persons with knowledge of the company's trade secrets, which may include employees, contractors, consultants, and attorneys. In these interviews, the interviewee first provides the names of other people who may have knowledge of the company's trade secrets. The interviewee next provides the names of locations within the company, including physical locations, computer files, and e-mail records that may contain trade secrets.

The interviewee next provides information about the trade secrets themselves, which may include the name of the potential trade secret, description of the potential trade secret, keywords associated with the potential trade secret, the subject area of the potential trade secret, the format of the potential trade secret, the company's product or service that depends on the potential trade secret, the company location where the potential trade secret was created or used, and the interviewee's name.

Once data is entered, various analyses may be requested of the system to be performed on the data. These analyses include:
Correlating the entered information across multiple potential trade secrets to find the multiple redundant entries that correspond to non-redundant potential trade secrets.
Integrating the redundant potential trade secrets into a single entry for each of the non-redundant potential trade secrets into which they have been correlated.
Calculating a value for each of the numeric values entered for the redundant potential trade secrets using a logical and mathematical formula, such as the mean and standard deviation for each numerical value, and entering such calculated value into the entry for each of the non-redundant potential trade secrets into which they have been correlated.
Compiling the resulting entries for the non-redundant potential trade secrets into a list of non-redundant potential trade secrets.
Preparing a final report documenting the resulting trade secret portfolio, including the non-redundant potential trade secrets, supporting documentation, and other data.
Utilizing data collected about the company's trade secrets, including the values of key fields and keywords, as search criteria for a data mining operation carried out on the locations where the company's trade secrets may be stored as identified during the interview process.
Cross-referencing the results of the said data mining operation to the data for the non-redundant potential trade secrets, and providing user access to the cross-referencing results.
Utilizing data collected about the company's trade secrets, including the values of key fields and keywords, as search criteria for a content filtering operation carried out on electronic communications leaving the company.
Utilizing data collected about the company's trade secrets, including the values of key fields and keywords, as search criteria for an electronic document scanning operation carried out on files read from or written to the company's email and file servers.

### BRIEF DESCRIPTION OF THE DRAWINGS

FIG. 1 is a block diagram of a trade secret discovery system in accordance with an illustrated embodiment of the invention;

FIG. 2 is a flow diagram of the methodology and structural flow of the preferred embodiment of the invention;

FIG. 3 is a flow diagram of the interview process of the preferred embodiment of the invention;

FIG. 4 is a flow diagram of the correlation process of the preferred embodiment of the invention;

FIG. 5 is a pictorial representation of the correlation of potential trade secrets into non-redundant potential trade secrets in the preferred embodiment of the invention;

FIG. 6 is a flow diagram of the integration process of the preferred embodiment of the invention;

FIG. 7 is a pictorial representation of an example of the integration of potential trade secrets into a non-redundant potential trade secret in the preferred embodiment of the invention;

FIG. 8 is a flow diagram of the report preparation process of the preferred embodiment of the invention;

FIG. 9 is a flow diagram of the data mining interface process of the preferred embodiment of the invention;

FIG. 10 is a flow diagram of the content filtering interface process of the preferred embodiment of the invention;

FIG. 11 is a flow diagram of the electronic document scanning interface process of the preferred embodiment of the invention; and

FIG. 12 is a block diagram of processors of the discovery digital computer of FIG. 1.

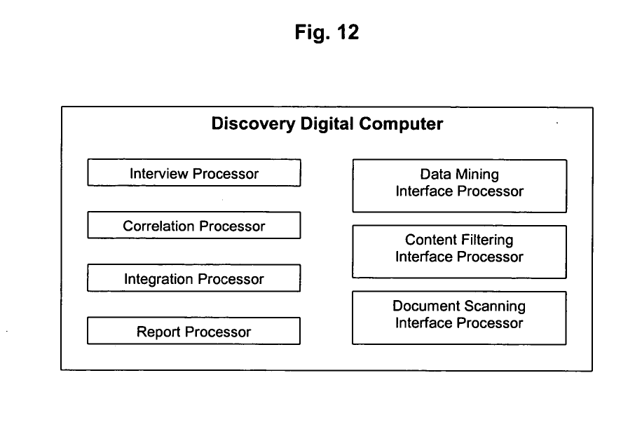

### DETAILED DESCRIPTION OF THE INVENTION

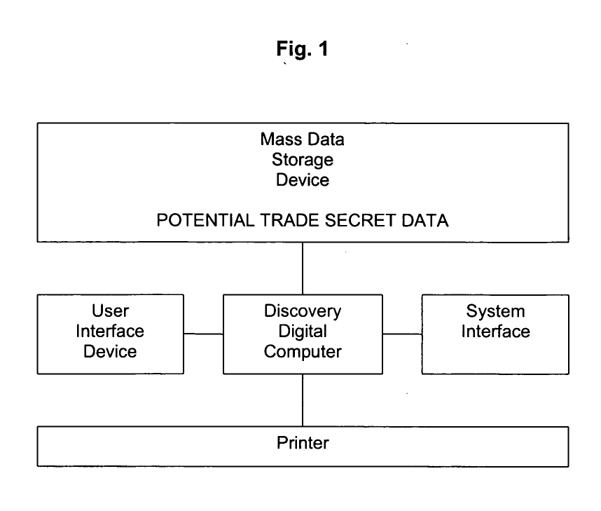

FIG. 1 is a generalized block diagram illustrating the structure of a specific computer system for implementing the invention for the discovery of trade secrets, including the collection, compilation, correlation, integration, categorization and reporting of data about trade secrets. In the context of this invention, this computer system is called the trade secret discovery system, or the discovery system.

FIG. 1 illustrates a means for data processing, called a digital computer, connected to one or more means for entering the data and displaying the data and the results of searches and calculations, called a user interface device. The user interface device may be, but is not limited to, any number and combination of the following, their equivalents, replacements, or improvements:
A directly connected monitor and keyboard.
A directly connected computer terminal.
A directly connected personal computer.
A computer terminal connected via a modem over telephone lines.
A personal computer connected via a modem over telephone lines.
A terminal connected via one or more local or wide area networks, including the Internet, intranet, private virtual network, satellite link, or other means.
A personal computer connected via one or more local or wide area networks, including the Internet, intranet, private virtual network, satellite link, or other means.
A terminal connected to another computer system, which is then connected to the described system via direct connection, a modem over telephone lines, or one or more local or wide area networks, including the Internet, intranet, private virtual network, satellite link, or other means.
A personal computer connected to another computer system, which is then connected to the described system via direct connection, a modem over telephone lines, or one or more local or wide area networks, including the Internet, intranet, private virtual network, satellite link, or other means.
A document scanner, connected via any of the above means.
Speech recognition device, connected via any of the above means.
Holographic or other projection device, connected via any of the above means.
Inductive neural pickup device, connected via any of the above means.
Direct optical nerve induction device, connected via any of the above means.

At least one means for storing the data entered into the system, as well as the programs required to implement the system, and the results of searches and calculations of the system that may be stored for later use or display, called a mass data storage device, is provided. This mass data storage device may be, but is not limited to, any combination of the following, their equivalents, replacements, or improvements:
Magnetic memory hard disk drive.
Magnetic memory flexible (floppy) disk drive.
CD-ROM (Compact Disc-Read Only Memory) drive.
FLASH-programmable ROM device or devices.
A molecular storage device consisting of data storage by the means of manipulating the structures of molecules within the device.

A means for printing out data, displays, and the results of searches and calculations, called a printer, may be provided. The printer may be, but is not limited to, any combination of the following, their equivalents, replacements, or improvements:
A directly connected printer.
A printer connected via a modem over telephone lines.
A printer connected via one or more local or wide area networks, including the Internet, intranet, private virtual network, satellite link, or other means.
A printer connected to the user input device.
An e-book, an electronic device for the display of downloaded text and data.
A bionic memory implant device, downloaded via any of the above means.

One or more means for connecting the system into other computer systems, called system interfaces, may be provided. A system interface may allow the system to input and output data (user interface functions), to print to one or more devices (printer functions), and to store and retrieve data (mass data storage functions) to and from another computer system that may provide some or all of the user interface functions, printer functions, or mass data storage functions of the system. A system interface may be implemented via direct connection, a modem over telephone lines, the use of removable storage media, or one or more local or wide area networks, including the Internet, intranet, private virtual network, satellite link, or other means.

In this document, “processor” means a device capable of performing the steps of the specific process under discussion, such as collection, correlation, integration. This is to be distinguished from the casual use of the term ‘processor’ in the computer field to refer to a single and distinct Central Processing Unit (“CPU”). In particular, various embodiments of the instant invention may use one CPU within the discovery system to perform the steps of each of the processors contained therein (e.g., within a multiprocessing environment), or one CPU within the discovery system to perform the steps of a plurality of the processors contained therein, or multiple CPUs to perform the steps of a single processor contained therein, or a combination of these.

It should be evident to those skilled in the art that the digital computer and its user interface, storage, printing devices, and system interfaces are an underlying technology for the implementation of the system, and the implementation of each of these aspects of the underlying technology are independent of the invention described.

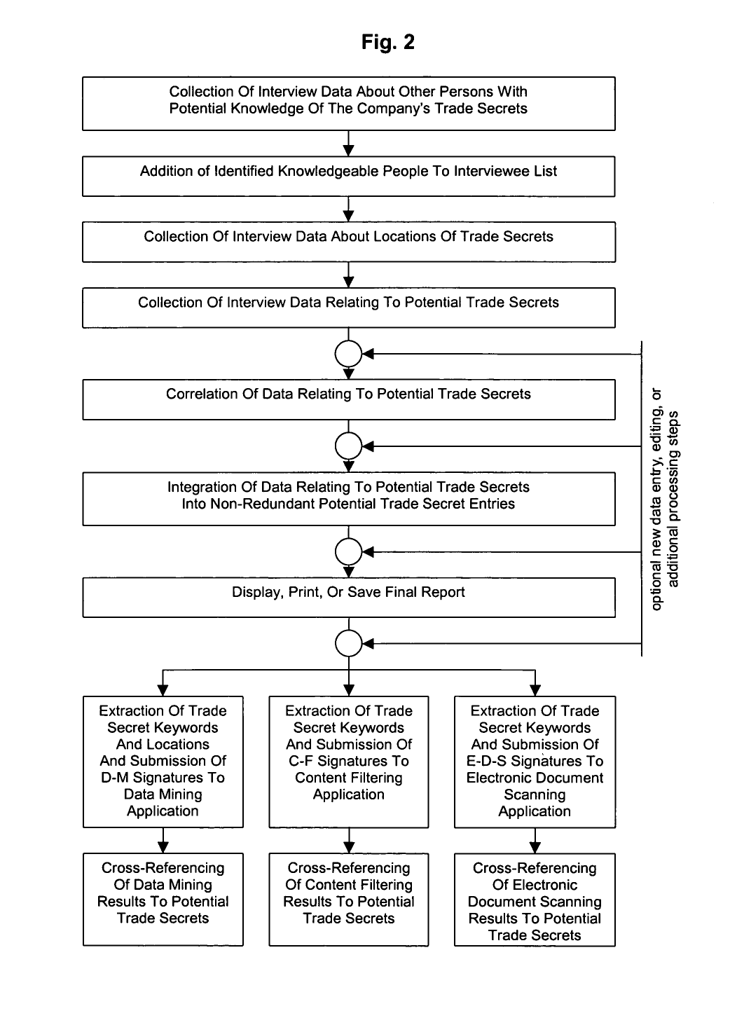

FIG. 2 is a detailed flow diagram illustrating a methodology and structural flow for a specific embodiment of the instant invention. The steps of collection of interview data relating to people with knowledge of the company's trade secrets, collection of interview data relating to the location of the company's trade secrets, collection of interview data relating to potential trade secrets, correlation of data relating to potential trade secrets, integration of data relating to potential trade secrets into non-redundant potential trade secrets, preparation and printing of a final report, submission of trade secret data and trade secret locations to a data mining process, correlation of data mining results to trade secret entries, generation of sets of criteria for content filtering applications, and generation of sets of criteria for electronic document scanning applications are illustrated.

Reprocessing of any step is permitted to incorporate the effects of new data entry, editing, or additional processing of any of the intermediate data at any step, as shown. Intermediate data here means all data collected or generated by the discovery system in any prior step of the process.

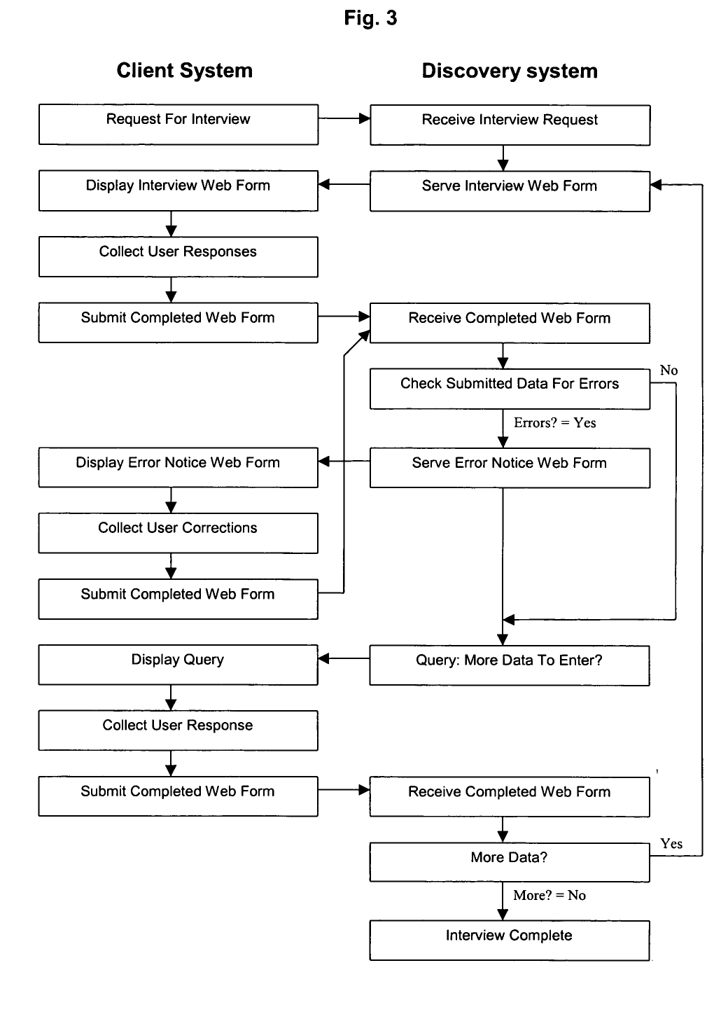

FIG. 3 is a detailed flow diagram illustrating a methodology and structural flow for the interview process by an interview processor (“IP1”) for a specific embodiment of the instant invention. As illustrated, the interview is conducted by means of web forms served by the discovery system to web browsers on client machines distributed throughout the company on the company's intranet. These client machines are the company's existing personal computers and other computers connected to the company's intranet. The data concerning potential trade secrets is entered into the discovery system by filling out and submitting these web forms to the discovery system during the interview process.

The interview process shown is used for collecting data about the people with knowledge of the company's trade secrets, data about the locations of the company's trade secrets, and data about the potential trade secrets themselves. The web forms served by the discovery system in the preferred embodiment illustrated may differ depending on which type of data is being collected, but the process used to serve the web forms and collect responses is the same.

In the preferred embodiment, the interview process includes a step for checking the internal consistency and conformance to rules of the potential trade secret data entered by the interviewee. Such rules may include that no field be left blank, or that a minimum of six keywords be entered for each potential trade secret. Errors or rule violations found during the checking step will result in a request to the interviewee, via a web form, to supply or correct the data.

In the preferred embodiment, the interview process includes a step for querying the interviewee at the end of the successful entry of the data for a potential trade secret as to whether the interviewee desires to enter another potential trade secret. If so, the discovery system serves a new interview web form. If not, the interview process is complete.

In alternative embodiments of the current invention, the interview process may be carried out by means of an alternate electronic communications system, on a terminal or monitor connected directly to the discovery system, through e-mailed exchanges between the interviewee and the discovery system, by means of voice synthesis and speech recognition equipment or software between the interviewee and the discovery system, by means of pencil and paper responses which are scanned or manually entered into the discovery system, or by other means. These variations on the method constitute additional embodiments utilizing the instant invention.

The key elements of the interview process in the current invention are 1) the distribution of a scripted interview to people knowledgeable about the company's trade secrets, 2) the collection of interview responses, and 3) entering the interview responses into the discovery system.

A listing of typical potential trade secret data that may be entered into the discovery system during the interview process is provided as an example as Table A.

TABLE A
EXAMPLE OF POTENTIAL TRADE SECRET
INTERVIEW DATA

```
Name Of The Potential Trade Secret
Date The Potential Trade Secret Was Created
Date The Potential Trade Secret Information Was Entered
Name Of The Interviewee
Originating Group/Department/Division For The Potential Trade Secret
Locations Where The Potential Trade Secret Is Or Was Created
Locations Where The Potential Trade Secret Is Or Was Stored
Locations Where The Potential Trade Secret Is Or Was Used
Locations Where The Potential Trade Secret Is Or Was Accessible
Keywords Associated With The Potential Trade Secret
Description Of The Potential Trade Secret
Subject Area Of The Potential Trade Secret
Format Of The Potrential Trade Secret
Product Or Service Enhanced By The Potential Trade Secret
Values For The Six Factors Of The Potential Trade Secret:
  Inside Knowledge
  Outside Knowledge
  Investment
  Economic Benefit
  Reproducibility
  Security Measures
Threat Assessment Of The Potential Trade Secret
```

Configuration data may also be entered into the discovery system. A listing of typical company data that may be entered into the discovery system is provided as an example in Table B.

TABLE B
EXAMPLE CONFIGURATION DATA

Company Locations
Table Of Keyword Synonyms
Choices For The Subject Areas For The Potential Trade Secrets
Choices For The Formats For The Potential Trade Secrets
Choices For The Products Or Services Enhanced By The Potential Trade
Secrets
Names And Definitions Of Values For The Six Factors Of A Trade Secret

Data entered into the discovery system may be retained indefinitely. Changes to information may be stored, along with the previous value, the date of change, and the user who made the change, in order to keep an audit trail and historical record.

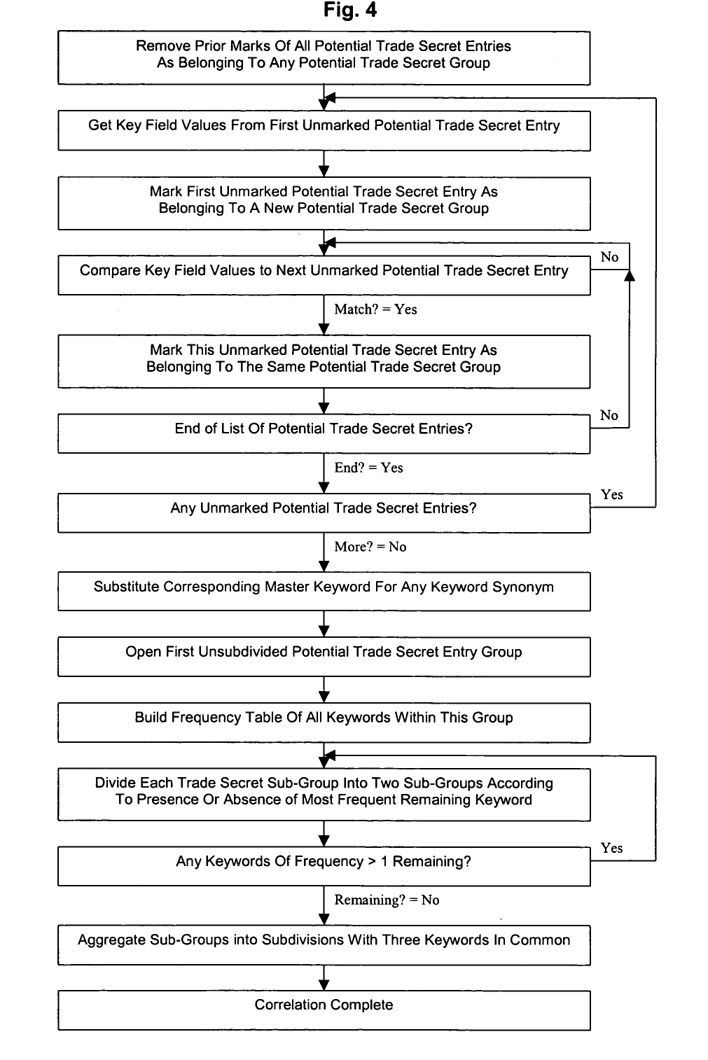

FIG. 4 is a detailed flow diagram illustrating the identification and correlation of redundant potential trade secrets by a correlation processor (“CP”) of the discovery system for a specific embodiment of the instant invention. The key fields of the potential trade secret entries used in the correlation process may include the subject area of the potential trade secret, the format of the potential trade secret, and the product or service enhanced by the potential trade secret.

The preferred implementation of the correlation process begins by comparing the values entered for key fields of the entry for the first potential trade secret to the same fields of the entries for all the other potential trade secrets in the system. All of the matching potential trade secret entries are marked as belonging to a single potential trade secret group.

In detail, this comparison process begins by comparing the values entered for key fields of the entry for the first unmarked potential trade secret to the same fields of the entries for all the other unmarked potential trade secrets in the system. All of the matching unmarked potential trade secret entries are marked as belonging to a single potential trade secret group.

The discovery system continues with the comparison process by repeating the previous step until all of the potential trade secret entries have been marked as belonging to potential trade secret groups.

Each of the potential trade secret groups can be characterized by the key fields as follows: <Subject Area><Format>for <Product>. Thus, example potential trade secret groups may be Manufacturing Recipe for Cola, Sales Forecast for All Beverages, and Marketing Plan for Fruit Drinks.

The preferred implementation of the correlation process continues by resolving the issue of synonym keywords. Any keyword that is listed as a synonym for a master keyword in the Table Of Keyword Synonyms will be replaced with the master keyword. For example, the master keyword “Coca-Cola” may have synonyms of “Coke” and “CC”. Any occurrence of either of the synonyms “Coke” or “CC” in the keyword field of any of the potential trade secrets is replaced by the master keyword “Coca-Cola” before further processing.

The preferred implementation of the correlation process continues by subdividing each potential trade secret group into more specific sub-groups based on the analysis of the keywords contained in the keyword fields of the potential trade secrets composing the potential trade secret group. Each resulting subdivision will contain all of the potential trade secrets which have three keywords in common. Thus, using the letters of the alphabet as example keywords, the following subdivisions of potential trade secrets would be made:
ABCDEF, ABCGHI, ABCIJK, ABDJKL
KLMNOP, KLMNPQ, KLMNRS
DEFGIJ, DEFHKL

Note that the potential trade secret whose entry contains the keywords ABCDEF appears in only one subdivision. ABCDEF belongs to the first subdivision—potential trade secret entries with ABC in common—and not to the third subdivision—potential trade secret entries with DEF in common. This is because A, B, and, C are the most common keywords in the potential trade secret entries. Thus, in this embodiment, potential trade secrets may only belong uniquely to one subdivision.

The specific embodiment of the instant invention illustrated forms the specific subdivisions in which all potential trade secret entries contain three keywords in common through a process of repeatedly dividing the group into subgroups based on the presence or absence of the most frequently occurring keyword remaining unprocessed. The resulting subgroups are then aggregated into the desired subdivisions in which all potential trade secret entries contain three keywords in common.

Alternative embodiments of the current invention may subdivide potential trade secret groups on the basis of a different number of keywords in common, subject to a rule that a potential trade secret may belong to two subdivisions, or through the use of a different sorting and aggregation process. These variations on the method constitute additional embodiments utilizing the instant invention.

Each subdivision created in this process constitutes one non-redundant potential trade secret.

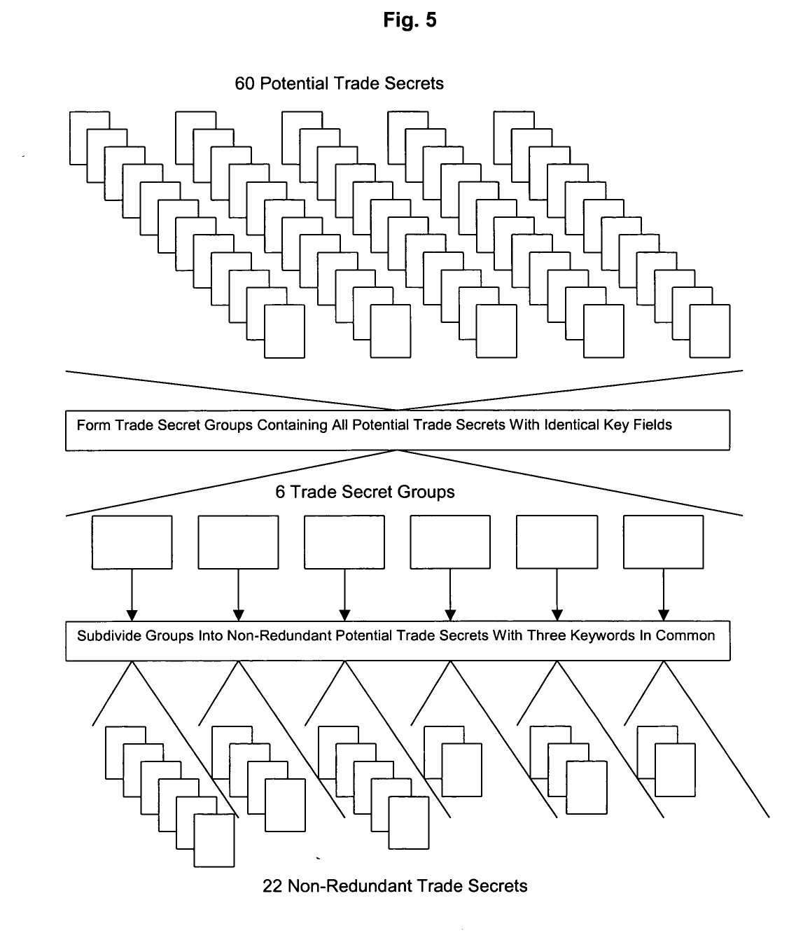

FIG. 5 is a pictorial representation of an example of the correlation of potential trade secrets into non-redundant potential trade secrets. The process of creating potential trade secret groups that contain all potential trade secrets with the same values of the key fields is shown. The process of subdividing potential trade secret groups into non-redundant potential trade secrets in which all of the constituent potential trade secrets have three keywords in common is also shown.

This mechanism is effective because trade secrets are not unitary or indivisible. When one considers the classic trade secret—the formula for Coca-Cola—it is actually a collection of trade secrets. The presence of each ingredient in the formula is itself a trade secret. The amount of each ingredient in the formula is itself a trade secret. The individual processes used to combine and cook the ingredients and the intermediate steps are themselves trade secrets. The entire collection—the presence of each ingredient, the amount of each ingredient, and the individual processes used to combine and cook them—is also a trade secret, called the formula for Coca-Cola.

Similarly, in litigation, trade secrets are aggregated. The theft of the formula for Coca-Cola would not be litigated as the theft of the knowledge of each ingredient, its amount, or the processes used to add it to the product. The theft of the formula for Coca-Cola would be valued, protected, and, if necessary, litigated as a single trade secret.

The goal and effect of the current invention in the correlation and integration of potential trade secrets into trade secret groups and subdivisions is to organize the trade secrets of the company into such aggregated trade secrets as can be valued, protected, and litigated, while cross-referencing these aggregations to the underlying individual data items, the potential trade secret entries.

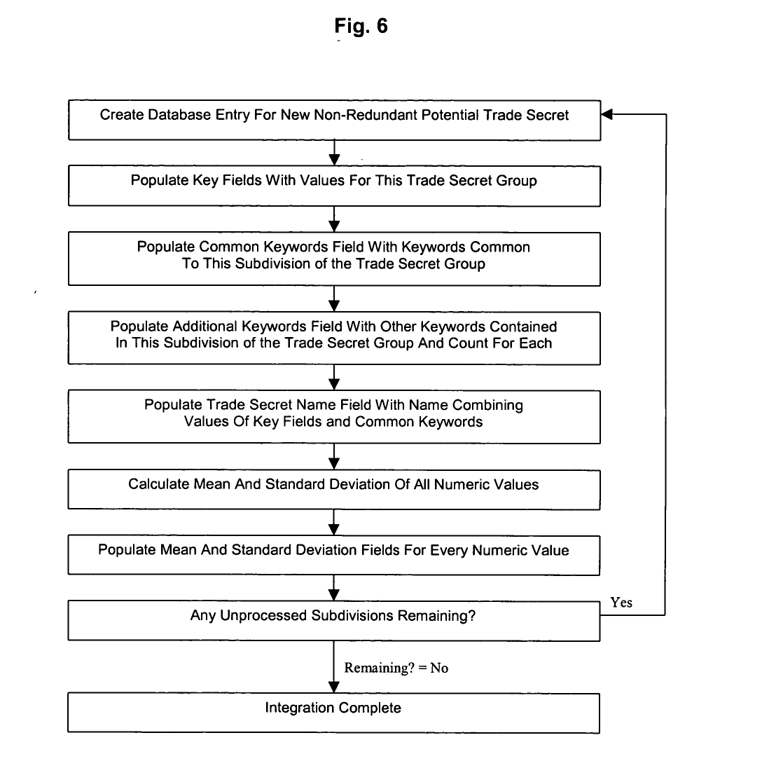

FIG. 6 is a detailed flow diagram illustrating the integration of potential trade secrets by an integration processor (“IP2”) of the discovery system for a specific embodiment of the instant invention. The discovery system integrates the data entries for all of the potential trade secrets within a non-redundant potential trade secret into one entry for each non-redundant potential trade secret.

In the preferred implementation of the integration process, two keyword entries are created in the entry for each non-redundant potential trade secret. One keyword entry is the entry for common keywords, containing all of the keywords common to every potential trade secret contained within the subdivision corresponding to the non-redundant potential trade secret.

The second keyword entry is the entry for additional keywords, containing all of the keywords in the keyword field of any of the potential trade secrets contained within the subdivision corresponding to the non-redundant potential trade secret, except for those keywords common to every potential trade secret contained within the subdivision. This entry also contains a count of the number of times each additional keyword appears within the subdivision.

In the preferred implementation of the integration process, two fields are created in the entry for each non-redundant potential trade secret from each field within the potential trade secret entries that contain a numeric value. The first of these fields contains the arithmetic mean of the numeric values for each of the potential trade secret entries. The second of these fields contains the standard deviation of the numeric values for each of the potential trade secret entries. Thus, for example, the field Inside Knowledge Factor in the potential trade secret entries results in the fields Inside Knowledge Factor Mean and Inside Knowledge Factor Standard Deviation in the corresponding non-redundant potential trade secret entry.

Alternative embodiments of the instant invention, or alternative methods offered as options to the user within the instant invention, may utilize different mathematical or logical functions to characterize a composite value and range of error for the fields containing numeric values. As an example, the geometric mean may be used to express the composite, and the maximum and minimum values may be used to express the range of error.

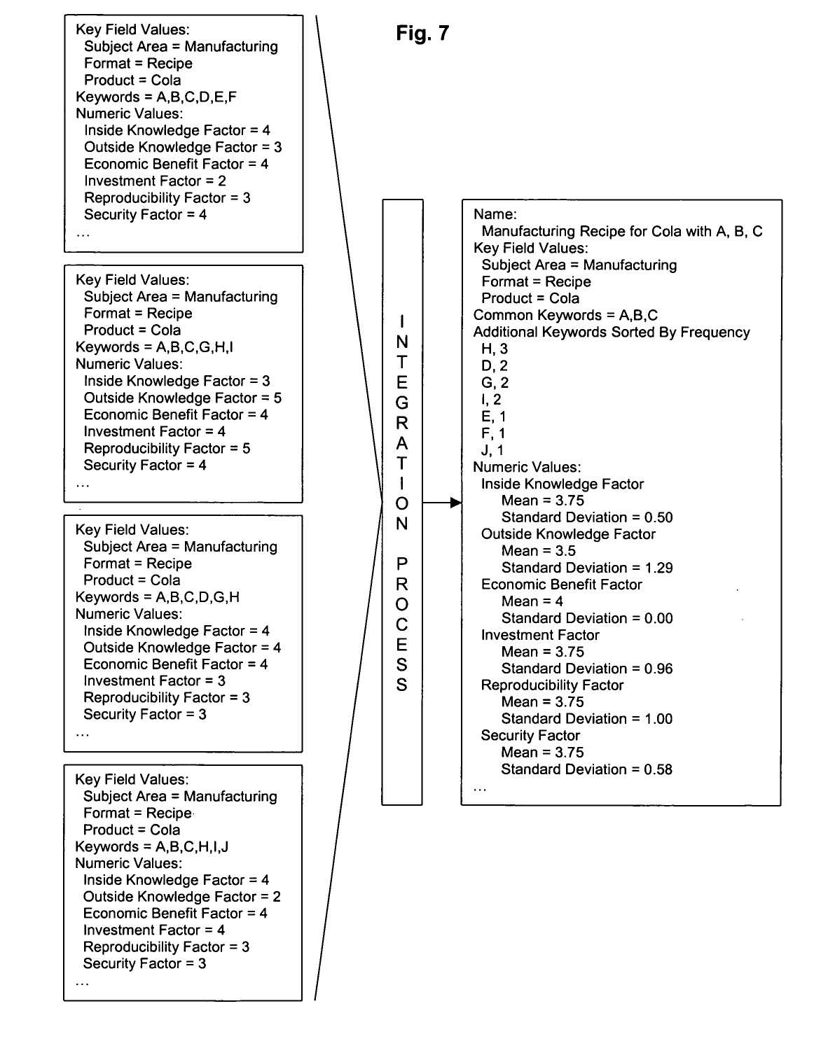

FIG. 7 is a pictorial representation of an example of the integration of potential trade secrets into a non-redundant potential trade secret in the preferred embodiment of the instant invention. In this example, four potential trade secrets within the same subdivision are integrated into a single potential trade secret. Not all fields or processing are shown.

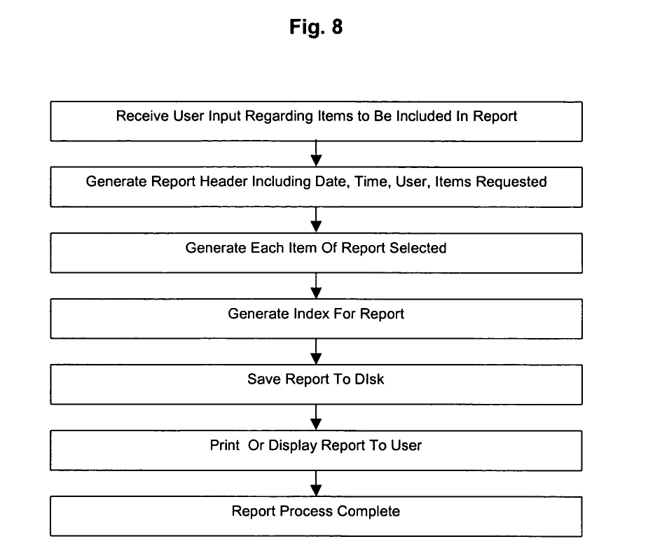

FIG. 8 is a detailed flow diagram illustrating the preparation of a final report or reports by a report processor (“RP”) of the discovery system for a specific embodiment of the instant invention. The report may include a list of all of the non-redundant potential trade secrets determined from the interview data, lists documenting the constituent potential trade secret entries for each non-redundant potential trade secret, statistical data regarding the total number of potential trade secret entries, the number of interviewees, the mean and standard deviation of the number of potential trade secret entries per interviewee, the number and identity of interviewees with a high number of potential trade secret entries, the number and identity of interviewees with a low number of potential trade secret entries, and other statistical and numerical data relating to the potential trade secret entries and the intermediate and final results of the various processes of the discovery system.

Alternative embodiments of the instant invention, or alternative methods offered as options to the user within the instant invention, may provide various reports in various formats relating to the interview data, the performance of the various processes of the discovery system, intermediate data of the various processes of the discovery system, and the final data produced by the discovery system. These variations on the method constitute additional embodiments utilizing the instant invention.

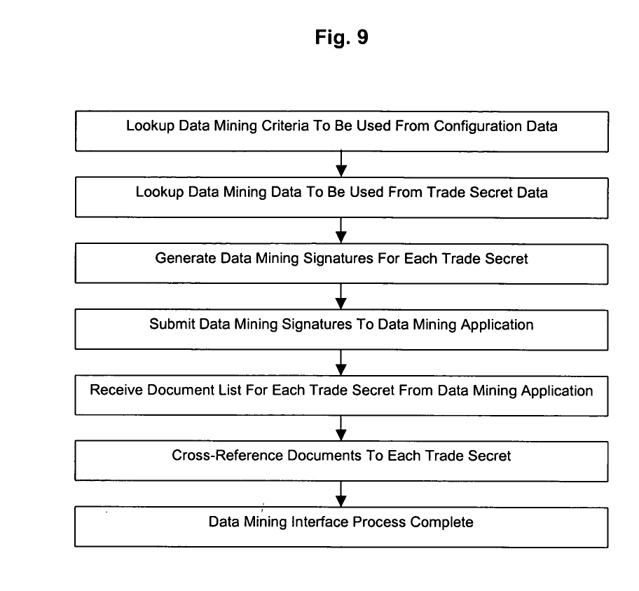

FIG. 9 is a detailed flow diagram illustrating the generation and submission of data about the non-redundant potential trade secrets to a data mining application, and the cross-referencing of the results, by a data mining interface processor (“DMIP”) of the discovery system for a specific embodiment of the instant invention. Data mining application means an automated method for searching through large amounts of data for information that meets specified search criteria.

The submission to the data mining application may take the form of search criteria (“data mining signatures”) to be applied to the document stores of the company. The data mining signature for each trade secret will be created using data about the trade secret collected or generated by the discovery system. The data used in creating the data mining signatures may include the contents of the key fields, the contents of the common keyword field, and the contents of the locations field.

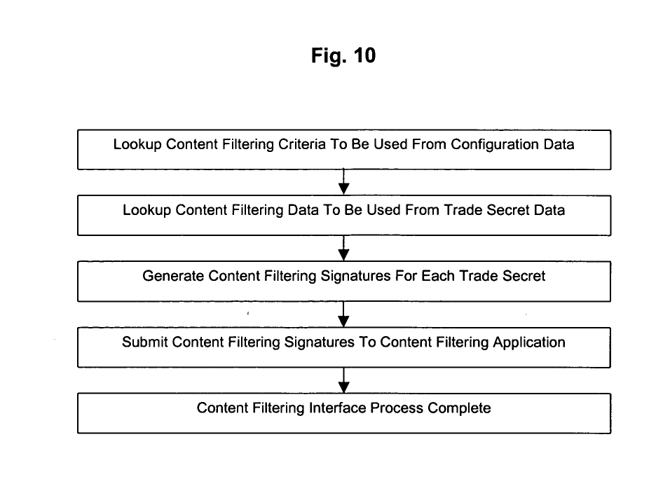

FIG. 10 is a detailed flow diagram illustrating the generation and submission of data about the non-redundant potential trade secrets to a content filtering application by a content filtering interface processor (“CFIP”) of the discovery system for a specific embodiment of the instant invention. Content filtering application means an automated method for determining whether an electronic communication should be allowed to be transmitted outside the company.

The submission to the content filtering application may take the form of search criteria (“content filtering signatures”) to be applied to the electronic communications submitted for transmission outside the company. The content filtering signature for each trade secret will be created using data about the trade secret collected or generated by the discovery system. The data used in creating the content filtering signatures may include the contents of the key fields, the contents of the common keyword field, and the contents of the locations field.

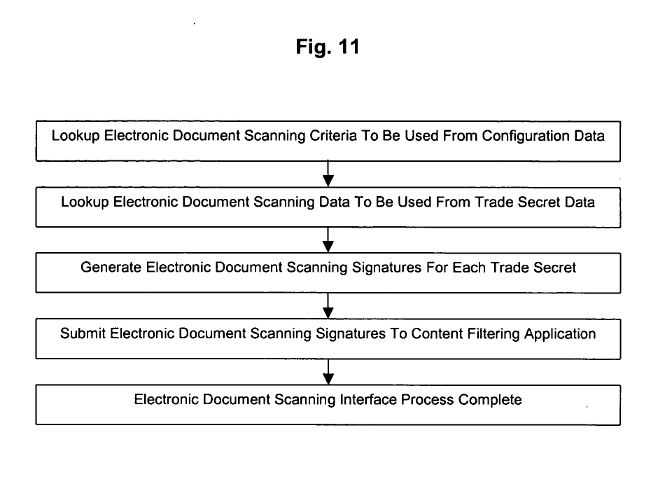

FIG. 11 is a detailed flow diagram illustrating the generation and submission of data about the non-redundant potential trade secrets to an electronic document scanning application by a document scanning interface processor (“DSIP”) of the discovery system for a specific embodiment of the instant invention. Document scanning application means an automated method for determining whether documents read from or written to the company's electronic document storage and distribution locations, such as email servers, files, servers, and web servers, contain data about trade secrets.

The submission to the electronic document scanning application may take the form of search criteria (“electronic document scanning signatures”) to be applied to documents read from or written to the company's electronic document storage and distribution locations. The electronic document scanning signature for each trade secret will be created using data about the trade secret collected or generated by the discovery system. The data used in creating the electronic document scanning signatures may include the contents of the key fields, the contents of the common keyword field, and the contents of the locations field.

It should be evident to persons skilled in the art that the methods disclosed for the discovery of trade secrets, including the collection, compilation, correlation, integration, categorization and reporting of data about trade secrets, have value when used independently or in combination. These methods are not anticipated or disclosed in the prior art. These unique methods are claimed when used independently or in combination in addition to the system for the discovery of trade secrets, including the collection, compilation, correlation, integration, categorization and reporting of data about trade secrets.

It should further be evident to persons skilled in the art that the methods disclosed have application to the discovery of all of the company's proprietary and confidential information, whether or not the legal trade secret status of that information is ever asserted or adjudicated. In particular, the terms “information audit”, applying to discovery of all of the company's proprietary and confidential information, and “evidence discovery audit”, applying to discovery of all of the company's information potentially subject to an evidence discovery process during litigation, are synonymous with the term “trade secret audit” in the context of the current invention.

It should further be evident to persons skilled in the art that the methods disclosed have wider application than to the specific system for the discovery of trade secrets, including the collection, compilation, correlation, integration, categorization and reporting of data about trade secrets. These methods are not anticipated or disclosed in the prior art. These unique methods are claimed in addition to the system for the discovery of trade secrets, including the collection, compilation, correlation, integration, categorization and reporting of data about trade secrets.

A specific embodiment of a method and apparatus for discovering trade secrets according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of discovering trade secrets of an organization, such method comprising the steps of:
collecting sets of trade secret information from a plurality of persons of the organization;
analyzing the collected sets of trade secret information using logical and mathematical formulae to identify and eliminate any redundancy among the sets of trade secret information to define a collection of potential trade secrets of the organization; and
generating a report regarding the identified trade secrets of the organization.

2. The method of discovering trade secrets as in claim 1 wherein the analysis step further comprises:
correlating among the sets of trade secret information having at least some redundant entries to identify sets of trade secret information that are related by redundancy and sets of trade secret information that are unrelated; and
integrating redundant entries among the respective sets into compiled sets of trade secret information with non-redundant entries that together with the sets of trade secret information with unrelated entries define a collection of potential trade secrets.

3. The method of discovering trade secrets as in claim 2, wherein the step of collecting sets of trade secret information further comprises conducting interviews of each person of the plurality of persons over an electronics communications network.

4. The method of discovering trade secrets as in claim 3, further comprising downloading a web form containing a plurality of information entry fields that request trade secret information from each person of the plurality of persons.

5. The method of discovering trade secrets as in claim 2, further comprising collecting information from each person of the plurality of persons regarding the identities of a plurality of other persons who may have information about the trade secrets of the organization.

6. The method of discovering trade secrets as in claim 5, further comprising collecting said identities by means of conducting interviews of each person of the plurality of persons over an electronics communications network.

7. The method of discovering trade secrets as in claim 6 further comprising downloading a web form containing a plurality of information entry fields that request said identities from each person of the plurality of persons.

8. The method of discovering trade secrets as in claim 2, further comprising collecting information from each person of the plurality of persons regarding the locations of the trade secrets of the organization.

9. The method of discovering trade secrets as in claim 8, further comprising collecting said information on locations by means of conducting interviews of each person of the plurality of persons over an electronics communications network.

10. The method of discovering trade secrets as in claim 9 further comprising downloading a web form containing a plurality of information entry fields that request said information on locations from each person of the plurality of persons.

11. The method of discovering trade secrets as in claim 2 wherein the step of correlating further comprises matching respective information entry fields of the plurality of fields of the trade secret information entries and marking trade secret information entries with matching fields as belonging to a single potential trade secret group.

12. The method of discovering trade secrets as in claim 11 wherein the plurality of matching information entry fields so matched further comprises a field for a subject matter of the trade secret.

13. The method of discovering trade secrets as in claim 11 wherein the plurality of matching information entry fields so matched further comprises a field for a format of the trade secret.

14. The method of discovering trade secrets as in claim 11 wherein the plurality of matching information entry fields so matched further comprises a field for a product or service enhanced by the trade secret.

15. The method of discovering trade secrets as in claim 11 wherein the step of correlating further comprises performing key word searching of the plurality of fields of each potential trade secret group.

16. The method of discovering trade secrets as in claim 15, further comprising improving the performance of said correlation by replacing any keywords encountered that are associated with a corresponding master keyword in a table of synonym keywords with the corresponding master keyword.

17. The method of discovering trade secrets as in claim 15 wherein the step of correlating further comprises subdividing each potential trade secret group into more specific sub-groups based on the analysis of keywords contained in the plurality of fields.

18. The method of discovering trade secrets as in claim 17 wherein the step of correlating further comprises subdividing each potential trade secret group into more specific sub-groups where each sub-group has at least a predefined number of keywords in common.

19. The method of discovering trade secrets as in claim 18, wherein the step of integrating further comprises using common keywords from keyword fields of multiple potential trade secret entries being integrated as a common keyword field in the resulting non-redundant trade secret entry.

20. The method of discovering trade secrets as in claim 18, wherein the step of integrating further comprises using non-common keywords and their frequency of occurrence in the keyword field of multiple potential trade secret entries being integrated as a non-common keyword field in the resulting non-redundant trade secret entry.

21. The method of discovering trade secrets as in claim 2 wherein the step of integrating further comprises forming predetermined mathematical quantities to represent a characteristic value and an error range for each numerical field of the plurality of trade secret entries being integrated.

22. The method of discovering trade secrets as in claim 21 wherein the step of integrating further comprises forming an arithmetic mean to represent the characteristic value for each numerical field of the plurality of trade secret entries being integrated.

23. The method of discovering trade secrets as in claim 21 wherein the step of integrating further comprises forming a standard deviation to represent the error range for each numerical field of the plurality of trade secret entries being integrated.

24. The method of discovering trade secrets as in claim 2, further comprising generating data mining signatures from the collected trade secret information, or by the results of logical or mathematical formulae applied thereto.

25. The method of discovering trade secrets as in claim 2, further comprising generating content filtering signatures from the collected trade secret information, or by the results of logical or mathematical formulae applied thereto.

26. The method of discovering trade secrets as in claim 2, further comprising generating electronic document scanning signatures from the collected trade secret information, or by the results of logical or mathematical formulae applied thereto.

27. A system for discovering trade secrets of an organization, such system comprising:
means for collecting sets of trade secret information from a plurality of persons of the organization;
means for analyzing the collected sets of trade secret information using logical and mathematical formulae to identify and eliminate any redundancy among the sets of trade secret information to define a collection of potential trade secrets of the organization; and
means for generating a report regarding the identified trade secrets of the organization.

28. The system for discovering trade secrets as in claim 27 wherein the means for analysis further comprises:
means for correlating among the sets of trade secret information having at least some redundant entries to identify sets of trade secret information that are related by redundancy and sets of trade secret information that are unrelated; and
means for integrating redundant entries among the respective sets into compiled sets of trade secret information with non-redundant entries that together with the sets of trade secret information with unrelated entries define a collection of potential trade secrets.

29. The system for discovering trade secrets as in claim 28, wherein the means for collecting sets of trade secret information further comprises means for conducting interviews of each person of the plurality of persons over an electronics communications network.

30. The system for discovering trade secrets as in claim 29, further comprising means for downloading a web form containing a plurality of information entry fields that request trade secret information from each person of the plurality of persons.

31. The system for discovering trade secrets as in claim 28, further comprising means for collecting information from each person of the plurality of persons regarding the identities of a plurality of other persons who may have information about the trade secrets of the organization.

32. The system for discovering trade secrets as in claim 31, further comprising means for collecting said identities by means of conducting interviews of each person of the plurality of persons over an electronics communications network.

33. The system for discovering trade secrets as in claim 32 further comprising means for downloading a web form containing a plurality of information entry fields that request said identities from each person of the plurality of persons.

34. The system for discovering trade secrets as in claim 28, further comprising means for collecting information from each person of the plurality of persons regarding the locations of the trade secrets of the organization.

35. The system for discovering trade secrets as in claim 34, further comprising means for collecting said information on locations by means of conducting interviews of each person of the plurality of persons over an electronics communications network.

36. The system for discovering trade secrets as in claim 35 further comprising means for downloading a web form containing a plurality of information entry fields that request said information on locations from each person of the plurality of persons.

37. The system for discovering trade secrets as in claim 28 wherein the means for correlating further comprises means for matching respective information entry fields of the plurality of fields of the trade secret information entries and marking trade secret information entries with matching fields as belonging to a single potential trade secret group.

38. The system for discovering trade secrets as in claim 37 wherein the plurality of matching information entry fields so matched further comprises means for recording a field for a subject matter of the trade secret.

39. The system for discovering trade secrets as in claim 37 wherein the plurality of matching information entry fields so matched further comprises a field for a format of the trade secret.

40. The system for discovering trade secrets as in claim 37 wherein the plurality of matching information entry fields so matched further comprises a field for a product or service enhanced by the trade secret.

41. The system for discovering trade secrets as in claim 37 wherein the means for correlating further comprises means for performing key word searching of the plurality of fields of each potential trade secret group.

42. The system for discovering trade secrets as in claim 41, further comprising means for improving the performance of said correlation by replacing any keywords encountered that are associated with a corresponding master keyword in a table of synonym keywords with the corresponding master keyword.

43. The system for discovering trade secrets as in claim 41 wherein the means for correlating further comprises means for subdividing each potential trade secret group into more specific sub-groups based on the analysis of keywords contained in the plurality of fields.

44. The system for discovering trade secrets as in claim 43 wherein the means for correlating further comprises means for subdividing each potential trade secret group into more specific sub-groups where each sub-group has at least a predefined number of keywords in common.

45. The system for discovering trade secrets as in claim 44, wherein the means for integrating further comprises means for using common keywords from keyword fields of multiple potential trade secret entries being integrated as a common keyword field in the resulting non-redundant trade secret entry.

46. The system for discovering trade secrets as in claim 44, wherein the means for integrating further comprises means for using non-common keywords and their frequency of occurrence in the keyword field of multiple potential trade secret entries being integrated as a non-common keyword field in the resulting non-redundant trade secret entry.

47. The system for discovering trade secrets as in claim 28 wherein the means for integrating further comprises means for forming predetermined mathematical quantities to represent a characteristic value and an error range for each numerical field of the plurality of trade secret entries being integrated.

48. The system for discovering trade secrets as in claim 47 wherein the means for integrating further comprises means for forming an arithmetic mean to represent the characteristic value for each numerical field of the plurality of trade secret entries being integrated.

49. The system for discovering trade secrets as in claim 47 wherein the means for integrating further comprises means for forming a standard deviation to represent the error range for each numerical field of the plurality of trade secret entries being integrated.

50. The system for discovering trade secrets as in claim 28, further comprising means for generating data mining signatures from the collected trade secret information, or by the results of logical or mathematical formulae applied thereto.

51. The system for discovering trade secrets as in claim 28, further comprising means for generating content filtering signatures from the collected trade secret information, or by the results of logical or mathematical formulae applied thereto.

52. The system for discovering trade secrets as in claim 28, further comprising means for generating electronic document scanning signatures from the collected trade secret information, or by the results of logical or mathematical formulae applied thereto.
